(19) United States
(12) Patent Application Publication
(10) Pub. No.: US 2008/0101832 A1
(43) Pub. Date: May 1, 2008

(54) Image forming apparatus and fixing device

(75) Inventors: Shinichi Yaoi, Kanagawa (JP); Yasushige Nakamura, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/783,980

(22) Filed: Apr. 13, 2007

(30) Foreign Application Priority Data
Oct. 25, 2006 (JP) P.2006-290488

(51) Int. Cl. G03G 15/20

(52) U.S. Cl. 399/336

(57) ABSTRACT

An image forming apparatus is provided and includes: an image forming section that forms an image on a recording material with an image forming material; a first irradiating section that irradiates the recording material with a first light; and a second irradiating section that irradiates the recording material with a second light different from the first light.

### CROSS-REFERENCE TO RELATED APPLICATION

This application is based on and claims priority under 35 USC §119 from Japanese Patent Application No. 2006-290488 filed Oct. 25, 2006.

### BACKGROUND

(i) Technical Field

The present invention relates to an image forming apparatus that forms an image on a recording material and to a fixing device that fixes an image to a recording material in the image forming apparatus.

(ii) Related Art

In the image forming apparatus in a xerographic scheme for example, it is a practice to heat and fuse a toner on a paper sheet, thereby to fix the image thereof on the paper.

### SUMMARY

According to an aspect of the invention, there is provided an image forming apparatus comprising:

an image forming section that forms an image on a recording material with an image forming material;

a first irradiating section that irradiates the recording material with a first light; and

a second irradiating section that irradiates the recording material with a second light different from the first light.

### BRIEF DESCRIPTION OF THE DRAWINGS

Exemplary embodiments of the present invention will be described in detail based on the following figures, wherein:

FIG. 1 shows an image forming apparatus according to an exemplary embodiment;

FIG. 2A is a side view of a fixing device, FIG. 2B is a top view of the fixing device as viewed in a direction of IIB, and FIG. 2C is a front view of the fixing device as viewed in a direction of IIC;

FIG. 3 is a block diagram showing a relationship between a control section, an image processing section and an exposure device;

FIG. 4A is a figure showing an emission intensity-against-wavelength characteristic of a flash lamp, and FIG. 4B is a figure showing optical absorbance-against-wavelength characteristic of yellow, magenta and cyan toners and oscillation wavelengths of color-based laser light sources;

FIG. 5A is a figure showing for explaining the spot of an exposure light formed by laser irradiation at a color-based exposure device, and FIG. 5B is a figure for explaining the spot of a fixing exposure light formed by laser irradiation at a laser-based fixing device;

FIG. 6 is a figure showing an example of an image formed on a paper;

FIG. 7A is a figure showing an example of color-based exposure data, FIG. 7B is a figure showing an example of light-distribution correcting data, and FIG. 7C is a figure an example of corrected data that is corrected for light distribution;

FIG. 8A is a figure showing an example of gloss enhancing data, and FIG. 8B is a figure showing an example of color-based fixing exposure data corrected for gloss enhancement;

FIG. 9 is a graph showing a relationship between an energy of a laser light (fixing exposure energy) outputted from an laser light source of the laser-based fixing device and a fixing ratio of a toner on a paper;

FIG. 10 is a figure showing an optical absorbance ratio-against-wavelength characteristic of a magenta toner in the visible and infrared region; and

FIGS. 11A and 11B show fixing devices according to other exemplary embodiments.

### DETAILED DESCRIPTION

With reference to the appended drawings, explanation will be now made in detail on exemplary embodiments (hereinafter, referred to as “embodiments”) of the present invention.

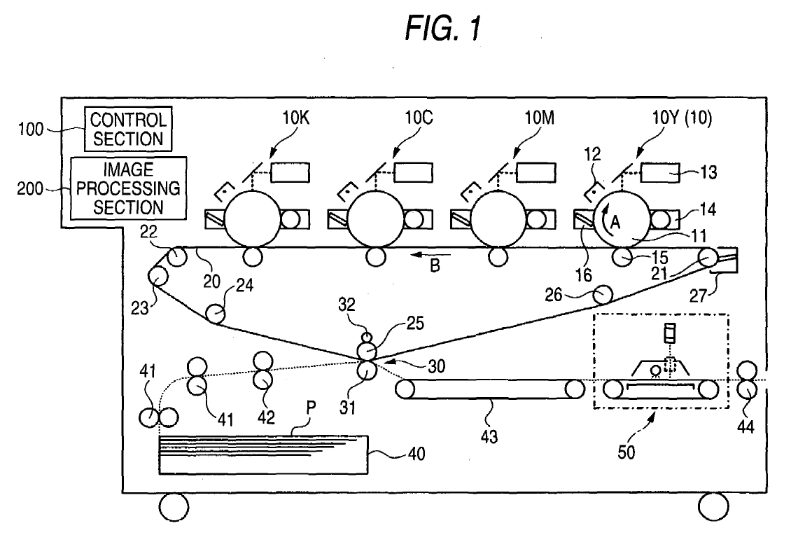

FIG. 1 is a figure showing an image forming apparatus according to an exemplary embodiment of the present embodiment. The image forming apparatus includes a plurality of image forming units 10 to form toner images of respective color components according to a xerographic scheme. The image forming units 10 concretely includes a yellow unit 10Y, a magenta unit 10M, a cyan unit 10C and a black unit 10K. Meanwhile, the image forming apparatus has an intermediate transfer belt 20 on which the color-component-based toner images formed by the respective image forming units 10 are to be transferred and held in order. Furthermore, the image forming apparatus has a secondary transfer device 30 that transfers the superposed images, transferred to the intermediate transfer belt 20, collectively onto a paper sheet P as a recording material. The image forming apparatus also has a fixing device 50 for fixing the secondary transferred image onto the paper sheet P. The image forming apparatus has a control section 100 that places those devices under control and an image processing section 200 that performs a processing for image forming.

Incidentally, in the image forming apparatus, the plurality of image forming units 10, the intermediate transfer belt 20, the secondary transfer device 30, etc. are to function as an image forming section.

The image forming units 10 are similarly structured except for the toner color to use. Hence, explanation is on the example with the yellow unit 10Y. The yellow unit 10Y has a photoreceptor drum 11 having a not-shown photosensitive layer and arranged for rotation in the direction of the arrow A. Around the photoreceptor drum 11, there are arranged a charging device 12, an exposure device 13, a development device 14, a primary transfer device 15 and a drum cleaner 16. Of those, the charging device 12 charges the photosensitive layer of the photoreceptor drum 11 to a potential. The exposure device 13 has a laser light source, not shown, that selectively irradiates, with a laser light, the photosensitive layer of the photoreceptor drum 11 charged at a potential by the charging device 12, thereby forming an electrostatic latent image. The development device 14 contains therein toners in the corresponding colors, as image forming materials. With the toners, development can be made as to the electrostatic latent image on the photosensitive layer of the photoreceptor drum 11. The primary transfer device 15 has a roll member rotatably arranged in contact, under pressure, with the photoreceptor drum 11. By applying a primary transfer bias to between the roll member and the photoreceptor drum 11, the toner image on the photoreceptor drum 11 is primarily transferred onto the intermediate transfer belt 20. The drum cleaner 16 is to remove residual substances, such as toner, from the photoreceptor drum 11 which completed the primary transfer.

The intermediate transfer belt 20 is rotatably supported over six support rolls. Of the support rolls, a drive roll 21 supports the intermediate transfer belt 20 and drives the intermediate transfer belt 20 to circulate. Meanwhile, follower rolls 22, 23, 26 give a tension to the intermediate transfer belt 20 and rotate following the intermediate transfer belt 20 being driven by the drive roll 21. A correction roll 24 gives a tension to the intermediate transfer belt 20 and serves as a steering roll that regulates the intermediate transfer belt 20 from moving zigzag in a direction nearly orthogonal to the circulating thereof. A backup roll 25 gives a tension to the intermediate transfer belt 20 and serves as a member constituting for a secondary transfer device 30, referred later.

In a position opposite to the drive roll 21 with respect to the intermediate transfer belt 20, a belt cleaner 27 is arranged to remove the residual substance, such as toner, from the intermediate transfer belt 20 which completed the second transfer.

The secondary transfer device 30 has a secondary transfer roll 31 arranged in contact, under pressure, with the intermediate transfer belt 20 at its surface holding the toner image, and a backup roll 25 arranged on the back side of the intermediate transfer belt 20 and assuming an opposite electrode to the secondary transfer roll 31. For the backup roll 25, a power feeding roll 32 is arranged in contact therewith to apply a secondary transfer bias in the same polarity as toner charging. Meanwhile, the secondary transfer roll 31 is grounded.

Meanwhile, a paper conveyance system has a paper container 40 receiving paper sheets P therein, a conveyance roll 41, a registration roll 42 for adjusting the position of a paper sheet P, a conveyance belt 43 and an outlet roll 44. In the paper conveyance system, the paper sheet P in a stack on the paper tray 40 is moved by the conveyance roll 41 and then stopped by the registration roll 42, then being fed to the secondary transfer device 30 into a position for second transfer. Meanwhile, the paper sheet P which completed the secondary transfer is conveyed to the fixing device 50 by way of the conveyance belt 43. The paper sheet P, exited the fixing device 50, is fed out of the apparatus by means of the outlet roll 44.

The fixing device 50, used in the embodiment, is explained in detail in the following.

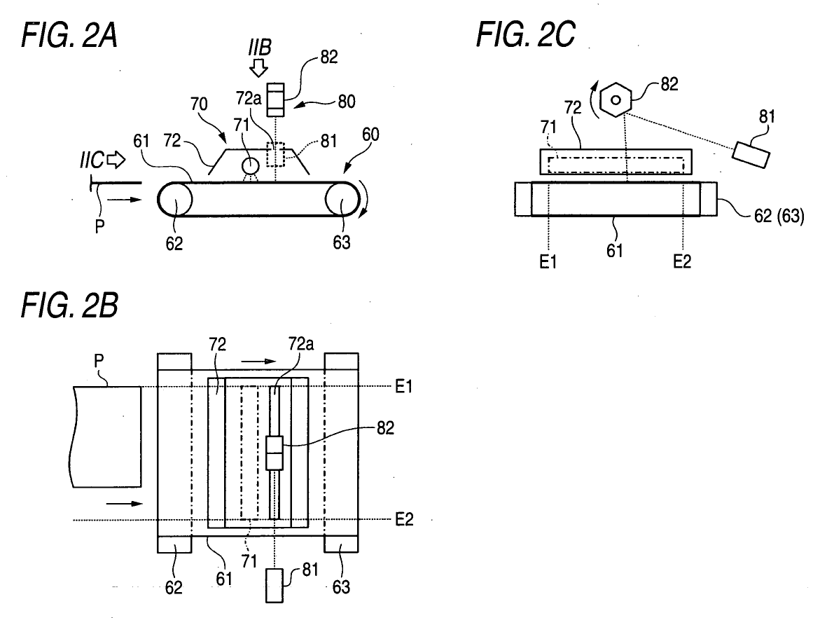

FIG. 2 is a figure showing a fixing device according to an exemplary embodiment of the invention. FIG. 2A is a side view of the fixing device 50 as viewed from the front of the image forming apparatus shown in FIG. 1, FIG. 2B is a top view of the fixing device 50 as viewed in the direction of IIB in FIG. 2A, and FIG. 2C is a front view of the fixing device 50 as viewed in the direction of IIC in FIG. 2(a).

The fixing device 50 has a paper conveyance device 60 that moves a paper sheet P holding thereon a toner image, a flash-based fixing device 70 arranged using an electric bulb, e.g. xenon lamp, that instantaneously gives off flash light to heat the toner image on the paper sheet being fed by the paper conveyance device 60 and in non-contact with the paper sheet P, and a laser-based fixing device 80.

The paper conveyance device 60 has an endless belt 61, a drive roll 62 and a follower roll 63 that allow the endless belt 61 to be stretched thereon for circulation. The endless belt 61 can be formed of heat-resistive resin, e.g. polyamide. The drive roll 62 and the follower roll 63 are arranged side by side horizontally so that the endless belt 61 stretched over those can move the paper sheet P horizontally. In the embodiment, the paper conveyance device 60 is set with a feed rate of the paper sheet P nearly equal to the rotation rate of the photoreceptor drum 11. Incidentally, the FIG. 1 image forming apparatus is allowed to form an image with reference to one end of the paper sheet P. To this end, the paper conveyance device 60 is to move the paper sheet P in the state the paper sheet P at its one side, extending orthogonal to the moving direction thereof, is aligned with a reference position El. Meanwhile, in the image forming apparatus, image forming is available with a paper sheet P in A3-size to feed longitudinally (A3SEF) or A4-size to laterally (A4LEF). In such a case, the maximum width of the paper sheet P to feed is given by a dimension defined between reference positions E1 and E2.

The flash-based fixing device 70 has a flash lamp 71 arranged facing to the upper surface of the endless belt 61 and a reflector plate 72 arranged above the flash lamp 71. In the embodiment, the flash lamp 71 uses a xenon lamp wherein, by intermittently supplying power from a not-shown power source, flashing light can be generated. Meanwhile, the reflector plate 72 is mirror finished at its inner recess surface so that radiation, given off in other directions than that toward the endless belt 61 from the flash lamp 71, can be reflected toward the upper surface of the endless belt 61. Incidentally, the reflector plate 72 is formed with a slit extending along the direction orthogonal to the direction of paper conveyance. The slit 72a is formed extending from the reference position E to the other end position E2.

Incidentally, in this embodiment, the flash-based fixing device 70 serves as a first irradiating section (light emitter with a flash lamp), a first heating section and a whole-part heating section (heater).

The laser-based fixing device 80 has a laser light source 81 to generate a laser light and a rotary multi-surfaced mirror 82 to reflect the laser light emitted from the laser light source 81 and illuminate it onto the endless belt 61 through scanning. The laser light source 81 separately outputs four laser lights having different oscillation wavelengths. Incidentally, the emission wavelengths of the laser lights will be detailed later. Meanwhile, the rotary multi-surfaced mirror 82 is structured, say, in a regular hexagonal prism and allowed to rotate at a constant rate in the direction of the arrow in the figure. Meanwhile, in the embodiment, the rotary multi-surfaced mirror 82 is arranged in a position immediately above the slit 72a provided in the reflector plate 72 of the flash-based fixing device 70 and nearly centrally with respect to the direction orthogonal to the direction of paper conveyance. Incidentally, a collimator lens, a cylindrical lens or the like can be arranged on the optical path at between the laser light source 81 and the rotary multi-surfaced mirror 82. Meanwhile, an fθ lens, a return mirror, a reflection mirror or the like can be provided between the rotary multi-surfaced mirror 82 and the endless belt 61.

In the embodiment, the laser-based fixing device 80 serves as a second irradiating section (laser-based light emitter), a second heating section and a local heating section (laser-based irradiator).

In the fixing device 50, the flash-based fixing device 70 and the laser-based fixing device 80 apply different radiations of light to the toners held on the paper sheet P, thereby fixing the toners to the paper in a non-contact scheme. In the fixing device 50, the flush-based fixing device 70 applies radiation to nearly the entire surface of the paper sheet P whereas the laser-based fixing device 80 irradiates, with a light, the paper sheet P locally at its toner-formed area.

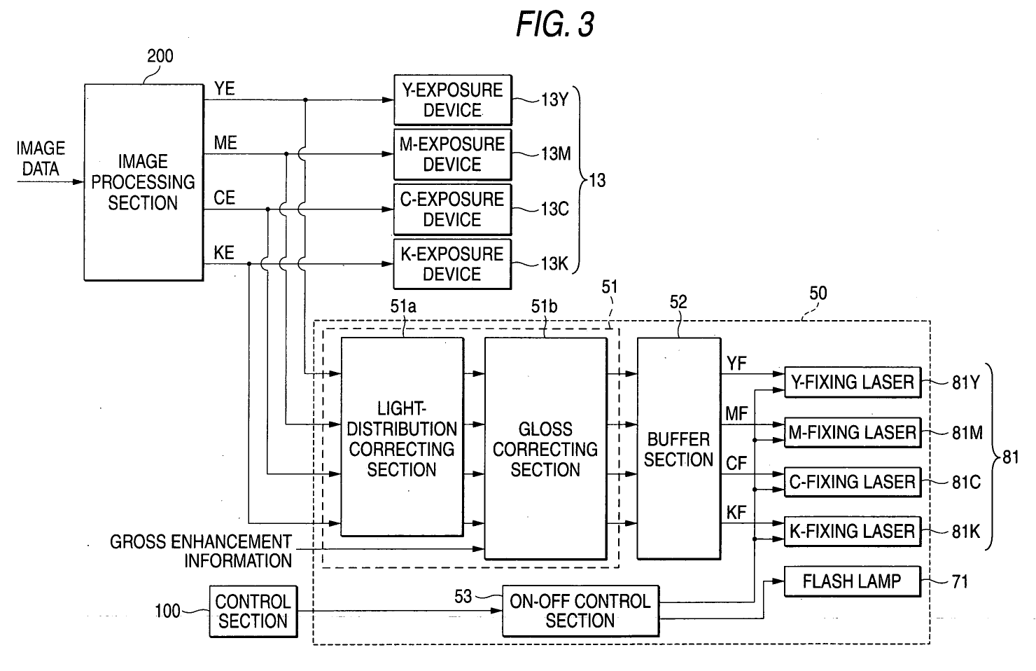

FIG. 3 is a block diagram for explaining the relationship between the control section 100, the image processing section 200, the exposure device 13 and the fixing device 50.

The image processing section 200 performs various processes on the image data inputted from a scanner, a computer terminal or the like, and output exposure data in YMCK four colors correspondingly to a full-color image. Specifically, the image processing section 200 outputs yellow-exposure data YE corresponding to a yellow image, magenta-exposure data ME corresponding to a magenta image, cyan-exposure data CE corresponding to a cyan image and black-exposure data KE corresponding to a black image. It is assumed that, in the embodiment, the image processing section 200 outputs color-based exposure data at a resolution of 600 spi (spot per inch) in directions of main scanning and sub-scanning. Of those, the Y exposure device 13Y, provided in the yellow unit 10Y, acquires yellow exposure data YE. The M exposure device 13M, provided in the magenta unit 10M, acquires magenta exposure data ME. The C exposure device 13C, provided in the cyan unit 10C, acquires cyan exposure data CE. The K exposure device 13K, provided in the black unit 10K, acquires black exposure data KE. Incidentally, the exposure devices 13 have respective laser light source, not shown. The laser light sources are each arranged to emit a light at an equal wavelength, say, in an infrared region, irrespectively of the color of a toner image to form. Meanwhile, the image processing section 200 outputs those of yellow exposure data YE, magenta exposure data ME, cyan exposure data CE and black exposure data KE, also to the fixing device 50 besides to the exposure devices 13.

The fixing device 50 further includes a light-amount correcting section 51, a buffer section 52 and an on-off control section 53. The light-amount correcting section 51 has a light-distribution correcting section 51a and a gloss correcting section 51b.

The light-amount correcting section 51 performs a light-amount correction on the color-based exposure data inputted from the image processing section 200. The light-amount correcting section 51 outputs the yellow-fixing exposure data YF, magenta-fixing exposure data MF, cyan-fixing exposure data CF and black-fixing exposure data KF obtained by making a light-amount correction, to the buffer section 52. In this case, the light-distribution correcting section 51a corrects the color-based exposure data correspondingly to the non-uniformity in the amount of light of from the flash lamp 71 with respect to the axial direction (with respect to the direction orthogonal to the direction of paper conveyance; main scanning direction). Meanwhile, when a gloss-enhancement process is requested to improve the gloss for an on-paper image, the gloss-correcting section 51b corrects the color-based exposure data in an area corresponding to gloss enhancement. Incidentally, gloss-enhancing process information is inputted together with image data.

The buffer section 52 temporarily stores the color-based exposure data inputted from the light-amount correcting section 51. The buffer section 52 outputs those of yellow-fixing exposure data YFE, magenta-fixing exposure data MF, cyan-fixing exposure data CF and black-fixing exposure data KF, to the corresponding ones of the laser light source 81. The laser light source 81 concretely includes a Y-fixing laser 81Y, an M-fixing laser 81M, a C-fixing laser 81C and K-fixing laser 81K. Although the laser light source 81 can be structured, say, by a semiconductor laser, a solid-state laser or a gas laser is usable.

The on-off control section 53 controls the flash-based fixing device 70 to put on/off the flash lamp 71 and the laser-based fixing device 80 to drive the laser light source 81.

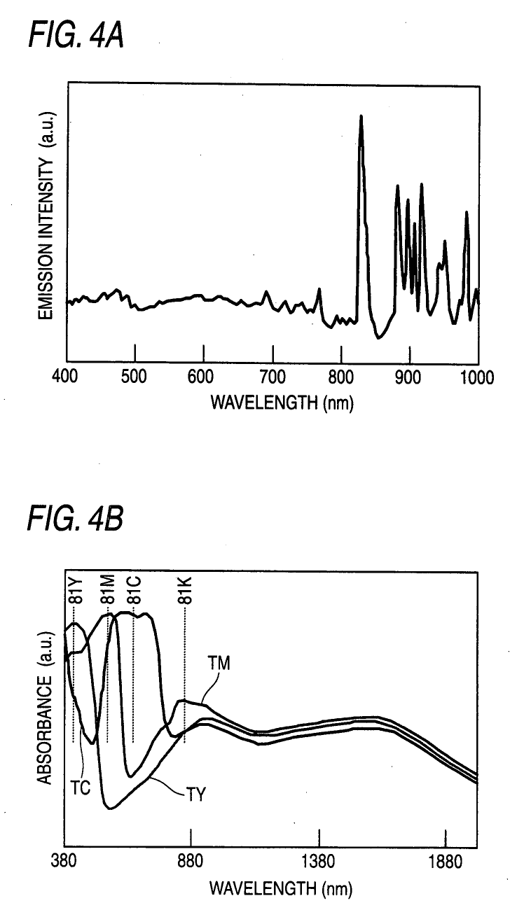

FIG. 4A shows an emission intensity-against-wavelength characteristic of the flash lamp 71 provided in the flash-based fixing device 70. The flash lamp 71 has an emission spectrum continuous in the visible to infrared region of light, thus having a plurality of emission peaks in the near-infrared region where the wavelength exceeds 800 nm. Namely, the flash lamp 71 can be considered as a light source to output a coherent one of radiation.

Meanwhile, FIG. 4B shows optical absorbance-against-wavelength characteristics of the yellow toner TY for use in the yellow unit 10Y, a magenta toner TM for use in the magenta unit 10M and a cyan toner TC for use in the cyan unit 10C. The YMCK color-based toners each contain a coloring agent, i.e. pigment, as a corresponding coloring material contained in an emulsified polymer resin (hereinafter, referred to as binder) that is transparent in a visible (400 to 800 nm) to infrared (800 to 1000 nm) region of light. Due to this, the yellow toner TY has a maximum value of absorption in the visible region at 400 nm, for example. The magenta toner TM has a maximum value of absorption in the visible region at 500 nm, for example. The cyan toner TC has maximum values of absorption in the visible regions at 350 nm and 600 to 700 nm.

In the embodiment, the yellow toner TY, the magenta toner TM and the cyan toner TC have respective infrared absorbents, in order to enhance the optical absorbance of the radiation of from the flash lamp 71 to the toner. By thus containing such infrared absorbents, the yellow toner TY, the magenta toner TM and the cyan toner TC are each given with also a light-absorbing band at infrared regions of 800 nm and 1500 nm, as shown in FIG. 4B. From the point of view of enhancing the optical absorbance over a broad region of wavelength, the black, yellow, magenta and cyan toners TB, TY, TM, TC preferably contain infrared absorbents having an absorption peak at an infrared region of 800 to 1700 nm. Such an infrared absorbent can use, say, cyanine compound, merocyanine compound, benzethiol metal complex, mercaptophenol metal complex, aromatic diamine metal complex, diimonium compound, aluminum compound, nickel complex compound, phthalocyanine compound, anthraquinone compound or naphthalocyanine compound or the like. Incidentally, though not shown in FIG. 4B, the black toner, for use in the black unit 10K, has an optical absorbance high in level approximate to the maximum values of absorption to the other yellow, magenta and cyan toners TY, TM, TC, in the visible to infrared region. Accordingly, there is no need to provide the infrared absorbent in the black toner.

In FIG. 4B, there is also shown emission wavelength of the Y-fixing, M-fixing, C-fixing and K-fixing lasers 81Y, 81M, 81C, 81K that are provided in the laser light source 81 of the laser-based fixing device 80. For example, the Y-fixing laser 81Y is to emit a light at a wavelength of 400 nm corresponding to the absorption peak to the yellow toner TY in the visible region. The M-fixing laser 81M is to emit a light at a wavelength of 500 nm corresponding to the absorption peak to the magenta toner TM in the visible region. The C-fixing laser 81C is to emit a light at a wavelength of 650 nm corresponding to the absorption peak to the cyan toner TC in the visible region. Namely, the Y-fixing, M-fixing and C-fixing lasers 81Y, 81M, 81C are each to emit a light at a wavelength corresponding to the complementary color of the Y toner, the M toner or the C toner (color ingredient to be absorbed to the relevant color toner). Meanwhile, the K-fixing laser 81K is to emit a light at a wavelength of 800 nm lying at an absorption peak to the yellow, magenta and cyan toners TY, TM, TC based on the infrared absorbent. Here, the wavelength 800 nm is also equal to the absorption wavelength of the black toner. The Y-fixing, M-fixing, C-fixing and K-fixing lasers 81Y, 81M, 81C, 81K can be considered as light sources capable of outputting an incoherent light. Note that the emission wavelength of the K-fixing laser 81K can be suitably set up, say, within a range of 300 to 1600 nm, in accordance with the type of an infrared absorbent to be contained in the yellow, magenta and cyan toners TY, TM, TC and the absorption of visible portion of light. In any case, the emission wavelength of establish corresponds to the absorption wavelength of the black toner.

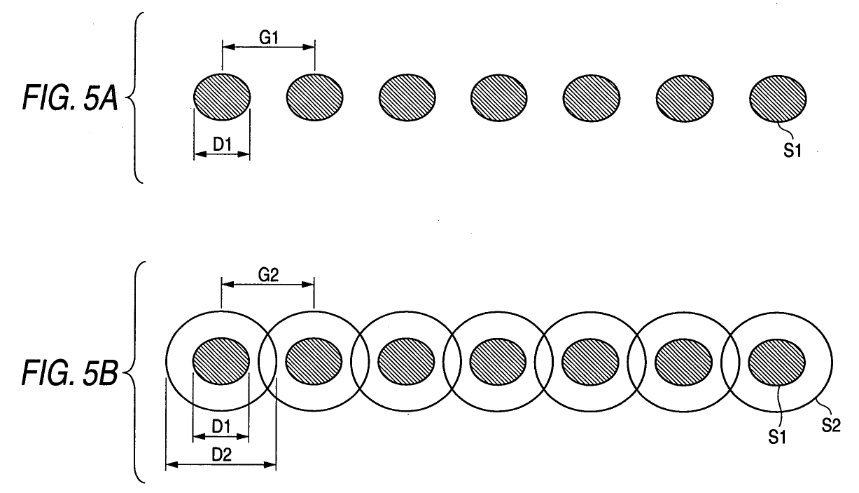

FIG. 5A is a figure for explaining an exposure spot due to an exposure light formed by laser irradiation of from the exposure device 13 (Y, M, C and K exposure devices 13Y, 13M, 13C, 13K). FIG. 5B is a figure for explaining a fixing spot S2 due to a fixing exposure light formed by laser irradiation of from the Y-fixing, M-fixing, C-fixing and K-fixing lasers 81Y, 81M, 81C, 81K constituting the laser light source 81 of the laser-based fixing device 80.

The exposure device 13 operates depending upon the color-based exposure data inputted from the image processing section 200. The image processing section 200 produces color-based exposure data at a resolution of 600 spi, as noted before. This provides an exposure spot-to-spot spacing G1, I.e. distance of between adjacent ones of exposure spots S1, of approximately 42.3 μm corresponding to 600 spi. Meanwhile, the maximum diameter of the impinging exposure spots S1, i.e. the spot diameter of exposure light, is set at an exposure spot diameter D1 at which not to overlap with the adjacent exposure spot Si.

Meanwhile, the laser light source 81 operates depending upon the color-based fixing exposure data obtained by correcting, at the light-amount correction section 51, for light amount the color-based exposure data inputted from the image processing section 200. Due to this, the interval G2 of fixing spots, i.e. distance between the adjacent ones of fixing spots S2, is given approximately 42.3 μm equal to the spacing G1 of exposure spots. Meanwhile, the maximum diameter of the impinging fixing spots S2, i.e. second light spot diameter, is set at a fixing spot diameter D2 greater than the exposure spot S1. In the embodiment, the fixing spot diameter D2 is set up in a manner overlapping between the adjacent ones of fixing spots S2.

The image forming process on the image forming apparatus is now explained. When image data is inputted to the image processing section 200, the control section 100 places the devices, constituting the image forming apparatus, under control to execute the operation of image forming.

At first, the image processing section 200 performs an image processing on the input image data and outputs yellow exposure data YE, magenta exposure data ME, cyan exposure data CE and black exposure data KE. The control section 100 causes the devices, constituting the image forming unit 10, to operate and form toner images in respective colors. For example, in the yellow unit 10Y, the exposure device 13 (Y exposure device 13Y) irradiates, with a laser light, the photoreceptor drum 11 which the charging device 12 charged uniformly, according to the yellow exposure data YE. This forms an electrostatic latent image. Then, the electrostatic latent image, formed on the photoreceptor drum 11, is developed by use of the yellow development device 14, to form a yellow toner image. In the other units of magenta, cyan and black 10M, 10C, 10K, toner images are formed in magenta, cyan and black respectively.

The color-based toner images on the respective photoreceptor drums 11 are primarily transferred onto the intermediate transfer belt 20 by means of the primary transfer device 15, at a primary transfer position where the photoreceptor drum 11 and the intermediate transfer belt 20 are in contact with each other. Meanwhile, after the primary transfer, the toner remaining on the photoreceptor drum 11 is cleaned away by the corresponding drum cleaner 16.

The color-based toner images, primarily transferred onto the intermediate transfer belt 20, are superimposed together on the intermediate transfer belt 20 and conveyed to a secondary transfer position due to circulation of the intermediate transfer belt 20. Meanwhile, the paper sheet P is conveyed, in a timing, to the secondary transfer position where it is nipped between the secondary transfer roll 31 and the intermediate transfer belt 20.

In the secondary transfer position, the toner image on the intermediate transfer belt 20 is secondary transferred onto the paper sheet P, under the influence of the electric field acting between the secondary transfer roll 31 and the backup roll 25. The paper sheet P, on which the toner image is secondarily transferred, is conveyed to the fixing device 50 through the conveyance belt 43. In the fixing device 50, the paper sheet P holding the toner image is conveyed by the paper conveyance device 60 so that radiation can be applied to the paper sheet P by the flash-based fixing device 70 and laser-based fixing device 80, whereby the toner image on the paper sheet P is heated up and fused thus being fixed on the paper sheet P. Then, the paper sheet P fixed with the toner image is allowed to exit to the outside of the image forming apparatus, thus completing the series of operation.

The fixing operation with the fixing device 50 is explained in greater detail.

In the fixing device 50, the light-amount correcting section 51 suitably performs a light-amount correction process on the yellow exposure data YE, magenta exposure data ME, cyan exposure data CE and black exposure data KE inputted from the image processing section 200. The buffer section 52 temporarily stores the yellow-fixing exposure data YF, magenta-fixing exposure data MF, cyan-fixing exposure data CF and black-fixing exposure data KF obtained by light-amount correction at the light-amount correcting section 51.

Meanwhile, the on-off control section 53 acquires an entrance timing of the paper sheet P to the fixing device 50, depending upon the control signal of from the control section 100.

The on-off control section 53 puts on the flash lamp 71 intermittently during the passage of the paper sheet P through the fixing device 50. Thereupon, the radiation from the flash lamp 71 is absorbed in the color-based toners that constitute a toner image on the paper sheet P so that the toner can be heated up and fused by light absorption.

Meanwhile, in the duration the paper sheet P passes the fixing device 50, the on-off control section 53 drives the color-based laser light source 81 depending upon the color-based fixing exposure data read out of the buffer 52. Namely, the Y-fixing laser 81Y is driven based upon the yellow-fixing exposure data YF, the M-fixing laser 81M is based upon the magenta-fixing exposure data MF, the C-fixing laser 81C is based upon the cyan-fixing exposure data CF and the K-fixing laser 81K is based upon the black-fixing exposure data KF. On this occasion, the on-off control section 53 reads color-based fixing exposure data out of the buffer section 52 and drives the color-based fixing laser light source 81 such that, in the image forming unit 10 for example, the toner image, formed based on color-based exposure data, is irradiated by a corresponding laser light in the timing reaching an irradiation position of the laser fixing device 80.

Here, the laser light of from the Y-fixing laser 81Y is scanned by the rotary multi-surfaced mirror 82 and selectively irradiated to the yellow toner held on the paper sheet P. Thereupon, the laser light irradiated from the Y-fixing laser 81Y is absorbed in the yellow toner on the paper sheet P because the Y-fixing laser 81Y has an emission wavelength corresponding to the absorption wavelength of the yellow toner. Thus, the yellow toner is heated up and fused by the light absorption.

Meanwhile, the laser light from the M-fixing laser 81M is scanned by the rotary multi-surfaced mirror 82 and selectively irradiated to the magenta toner held on the paper sheet P. Thereupon, the laser light irradiated from the M-fixing laser 81M is absorbed in the magenta toner on the paper sheet P because the M-fixing laser 81M has an emission wavelength corresponding to the absorption wavelength of the magenta toner. Thus, the magenta toner is heated and fused by the light absorption.

The laser light of from the C-fixing laser 81C is scanned by the rotary multi-surfaced mirror 82 and selectively irradiated to the cyan toner held on the paper sheet P. Thereupon, the laser light irradiated from the C-fixing laser 81C is absorbed in the cyan toner on the paper sheet P because the C-fixing laser 81C has an emission wavelength corresponding to the absorption wavelength of the cyan toner. Thus, the cyan toner is heated up and fused by the light absorption.

The laser light of from the K-fixing laser 81K is scanned by the rotary multi-surfaced mirror 82 and selectively irradiated to the black toner held on the paper sheet P. Thereupon, the laser light irradiated from the K-fixing laser 81K is absorbed in the black toner on the paper sheet P because the K-fixing laser 81K has an emission wavelength corresponding to the absorption wavelength of the black toner. Thus, the black toner is heated up and fused by the light absorption.

In this manner, the color-based toner on the paper sheet P is irradiated with a light from the flash lamp 71 and a laser light corresponding to the toner color with a result that a toner image is fixed on the paper sheet P. In the embodiment, the laser light source 81 is placed under control to irradiate a color-based laser light in a manner not exceeding the paper width, i.e. a length in the main scanning direction of the paper sheet P to be moved by the paper conveyance device 60, and the paper length, i.e. a length thereof in the sub-scanning direction. This avoids the laser light, irradiated from the laser light source 81, from impinging directly upon the endless belt 61.

In the embodiment, the laser light source 81 of the laser fixing device 80 provides a fixing spot diameter D2 greater than the exposure spot diameter D1 in the exposure device 13, as noted before. Accordingly, even in case the laser light of from the laser light source 81 somewhat deviates in its irradiation position, the toner on the paper sheet P is to be positively irradiated by the corresponding laser light. Meanwhile, because the K-fixing laser. 81K has an emission wavelength corresponding to the absorption wavelength of the other yellow, magenta and cyan toner TY, TM, TC, the other color toner put nearby the black toner can be heated up also by the laser light of from the K-fixing laser 81K.

Here, the process in the light-amount correcting section 51 is explained while using a concrete example.

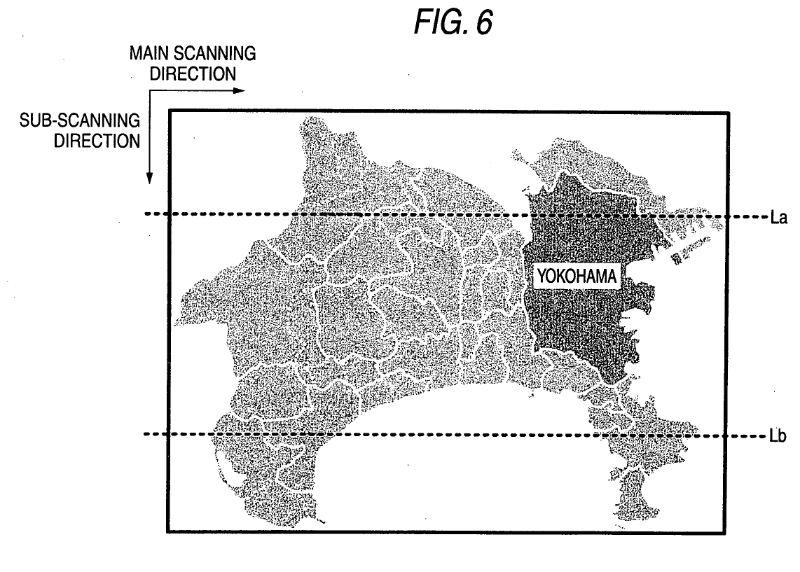

FIG. 6 is a figure of an example of an image to form on the paper sheet P. It is assumed here to form an image corresponding to so-called A4 LEF that main scanning is taken in the lengthwise direction of A4-size paper sheet P. Meanwhile, the image to form is a map of Kanagawa prefecture wherein the image is to form in green while texts are in black. In the map, Yokohama city is enhanced with green gloss.

Now explanation is made on the producing process of color-based fixing-exposure data corresponding to the n-th line La with respect to the direction of sub-scanning.

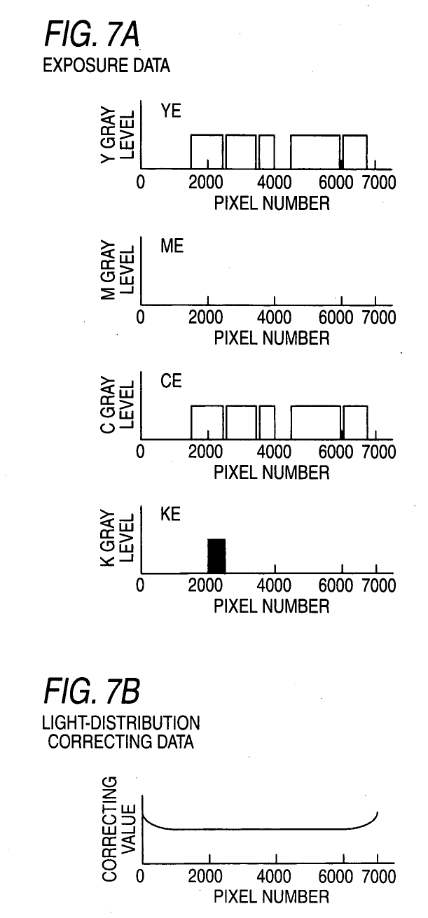

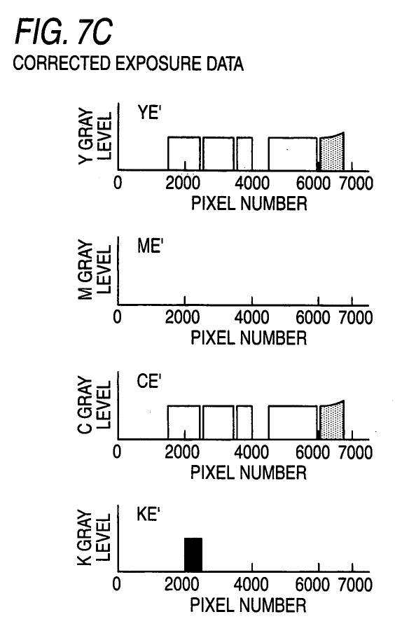

FIG. 7A shows the yellow, magenta, cyan and black exposure data YE, ME, CE, KE for the a-th line La, inputted from the image processing section 200. In FIG. 7A, pixel number is taken on the horizontal axis while color-based output gray level is taken on the vertical axis. On the line La, a green image is formed over the pixel numbers of 1500 to 4000 and 4500 to 6500. As a consequence, the yellow and cyan exposure data YE, CE has predetermined output gray levels at those pixel numbers. In this example, the magenta exposure data ME has an output gray level of 0 at all the pixel values. Meanwhile, on the line La, a black text image is formed at pixel numbers of 2000 to 2500. As a consequence, the black exposure data KE has a predetermined output gray level at a part of the pixel numbers.

FIG. 7B exemplifies a light-distribution correcting data for use in correcting for light amount by the light-distribution correcting section 51. In the figure, pixel number is taken on the horizontal axis while correction value is on the vertical axis. In this example, correction value is constant centrally with respect to the main scanning direction (pixel numbers 1000 to 6000) whereas, at the both sides thereof (pixel numbers 0 to 1000 and 6000 to 7000) correction value is set up greater as the opposite end is neared.

The reason of using the light-distribution correcting data shown in FIG. 7B in the light-distribution correcting section 51a is because of the following reason. Namely, the flash lamp 71 used in the flash-based fixing device 70 has an emission amount that tends to lower at the both ends with respect to the main scanning direction rather than at the central region thereof. This results in a possibility that the toner, formed at the both ends with respect to the main scanning direction, is insufficiently fixed only by the radiation of from the flash lamp 71. For this reason, the embodiments is secured with a favorable fixing capability thoroughly in the main scanning direction by correcting the light distribution in the direction offsetting the light-distribution characteristic of the flash lamp 71 and by supplementing, at the laser-based fixing device 80 side, the deficient amount of light due to the flash lamp 71.

FIG. 7C shows color-based corrected data obtained by correcting the FIG. 7A color-based exposure data by use of the FIG. 7B light-distribution correcting data. In this example, the color-based exposure data is multiplied by light-distribution correcting data on a corresponding pixel-number basis, thereby calculating the color-based corrected exposure data. Note that those are respectively referred to as yellow corrected data YE′, magenta corrected data ME′, cyan corrected data CE′ and black corrected data KE′, in the following explanation. In this example, correction is made such that the yellow corrected data YE′ and the cyan corrected data CE′ at the pixel numbers 6000 and the subsequent (shown with halftone dots in the figures) have respective output gray levels greater than the former ones of data.

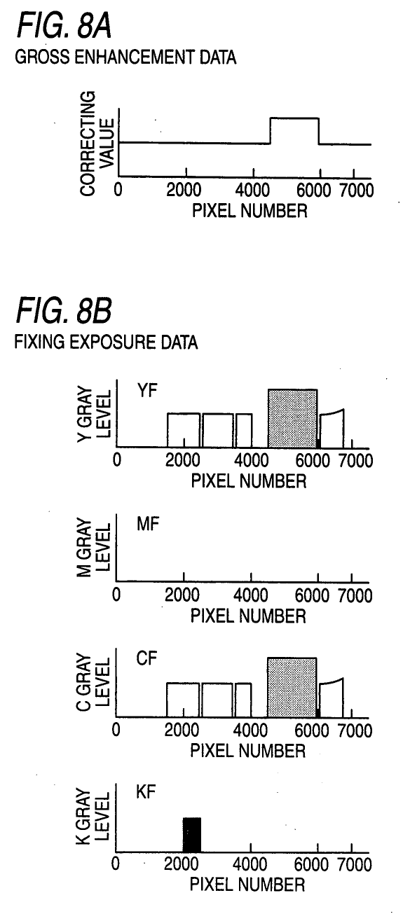

FIG. 8A shows gloss enhancement data for a-th line La to be inputted to the gloss correcting section 51b. In the figure, pixel number is taken on the horizontal axis while correction value is on the vertical axis. For the line La, because the instruction of gloss enhancement is given at pixel numbers 4500 to 6000, correcting value is set greater at pixel numbers 4500 to 6000.

FIG. 8B shows the yellow-fixing exposure data YF, magenta-fixing exposure data MF, cyan-fixing exposure data CF and black-fixing exposure data BF obtained by correcting the FIG. 7C color-based corrected data by use of FIG. 8A gloss enhancing data. In this example, color-based corrected data is multiplied by the gloss enhancing data on the corresponding pixel-number basis, thereby calculating color-based fixing-exposure data. In this example, corrections is made such that the yellow-fixing exposure data YF and the cyan-fixing exposure data at pixel numbers 4500 to 6000 have respective output gray levels increased greater.

By making such correction for light amount, the radiation in an amount insufficient with only the flash lamp 71 can be supplemented from the laser light source 81, for the toner held on the paper sheet P at ends with respect to the main scanning direction. As a result, it is possible to obtain an image fixed well throughout the surface of the paper sheet P.

With such correction for light amount, by increasing the amount of irradiation from the laser light source 81 to the region where desired for gloss enhancement for example, the toner held on the region can be fused to a greater extent. As a result, gloss can be enhanced higher than the other region. Conversely, by decreasing the amount of irradiation from the laser light source 81 to the region where gloss enhancement is not desired, gloss can be provided lower than the other region.

Incidentally, when producing color-based fixing exposure data corresponding to a b-th line Lb with respect to the sub-scanning direction shown in FIG. 6 for example, the following is executed. Namely, the light-distribution correction section 51a performs a light-amount correction on each pixel by use of the FIG. 7B light-distribution correcting data, similarly to the line La. Meanwhile, in the gloss correcting section 51b, because no light-amount enhancing regions exist on the line Lb, gloss correction is performed by using the equal correcting value throughout the region with respect to the main scanning direction.

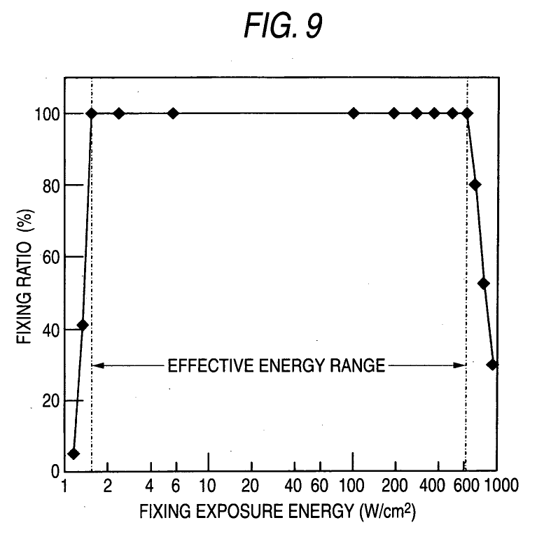

FIG. 9 shows a relationship between a fixing exposure energy given by the laser light outputted from the laser light source 81 of the laser fixing device 80, i.e. laser-light intense density, and a fixing ratio of the toner held on the paper sheet P. From the figure, it can be seen that a fixing ratio of approximately 100% can be obtained under the condition that fixing exposure energy is within a range of from 1.5 W/cm² or greater to 630 W/cm² or smaller. In the case the fixing exposure energy is smaller than 1.5 W/cm², the fixing ratio decreases because the toner is insufficiently fused by laser irradiation. Meanwhile, where the fixing exposure energy exceeds 630 W/cm², the fixing ratio decreases because of the occurrence of scorch in the toner or the paper sheet P due to laser irradiation.

In the embodiment, emission wavelength is set to the Y-fixing laser 81Y correspondingly to the absorption wavelength of the yellow toner TY, emission wavelength is to the M-fixing laser 81M correspondingly to the absorption wavelength of the magenta toner TM, and emission wavelength is to the C-fixing laser 81C correspondingly to the absorption wavelength of the cyan toner TCY. Furthermore, emission wavelength is set to the K-fixing laser 81K correspondingly to the absorption wavelength of the infrared absorbent contained in the yellow, magenta and cyan toners TY, TM, TC. The emission wavelength for the k-fixing laser 81K can be determined in the following manner.

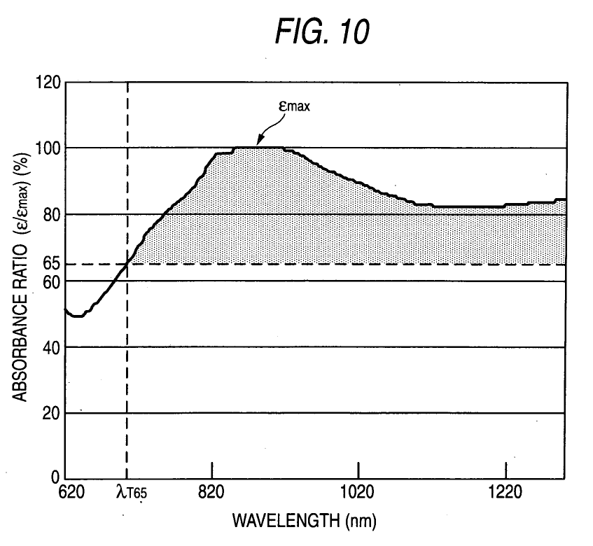

FIG. 10 shows an optical absorbance-against-wavelength characteristic of the magenta toner TM in the visible and infrared regions. Note that the absorption band existing in the infrared region is due to the infrared absorbent, which also exists in the yellow and cyan toners TY, TC. Here, optical absorbance ratio is a normalized one by dividing the optical absorbance ε at each wavelength by the maximum optical absorbance εmax that is the maximum value of optical absorbance. Meanwhile, Table 1 shows a relationship between an optical absorbance ratio and a fixing characteristic obtained, where laser lights are irradiated at various wavelengths of the magenta toner TM on the paper sheet P.

TABLE 1

| Laser wavelength | Optical absorbance | |
|---|---|---|
| (nm) | ratio (%) | Result |
| 675 | 56.0 | Bad |
| 690 | 60.1 | Not bad |
| 790 | 86.4 | Good |
| 800 | 88.8 | Good |
| 808 | 91.5 | Good |
| 810 | 92.2 | Good |
| 825 | 97.1 | Good |
| 830 | 98.2 | Good |
| 860 | 99.9 | Good |
| 940 | 98.0 | Good |
| 980 | 93.1 | Good |
| 1053 | 86.4 | Good |
| 1064 | 85.5 | Good |

From FIG. 10 and Table 1, it can be seen that the fixing characteristic decreases where a laser light is irradiated at a wavelength having an absorption ratio (ε/εmax) of smaller than 65%. Namely, in order to obtain a favorable fixing characteristic, it is satisfactory to select, for the K-fixing laser 81K, an emission wavelength of λT65 where ε/εmax≧65% is held.

As explained so far, in the embodiment, the toner image held on the paper sheet P can be fixed positively by virtue of the combination of the flash-based fixing device 70 for radiating an incoherent radiation and the laser-based fixing device 80 for emitting a coherent light.

Meanwhile, in the embodiment, the flash-based fixing device 70 is to radiate light to the entire of the paper sheet P whereas the laser-based fixing device 80 is to emit a light locally to the corresponding color toner on the paper sheet P. As a result, the color-based toners on the paper sheet P may be fused and fixed more positively.

Furthermore, in the embodiment, for the region where is deficient in the amount of radiation from the flash-based fixing device 70, the laser-based fixing device 80 is to emits a light in an increased amount. This may fix the color-based toners onto the paper sheet P irrespectively of the position.

In the fixing device 50 according to the aspect of the invention, the combination of the flash-based fixing device 70 and the laser-based fixing device 80 may mutually complement the required portions of heat for fixing. This may reduce the consumption of power as compared to the case using the flash-based fixing device 70 or the laser-based fixing device 80 singly.

Furthermore, in the embodiment, the combination of the flash-based fixing device 70 and the laser-based fixing device 80 may supply a sufficient amount of heat to the color-based toner, correspondingly reducing the content of infrared absorbent in the yellow, magenta and cyan toners TY, TM, TC. This may reduce the cost for the toners and suppresses the toner color from changing due to the infrared absorbent.

In the embodiment, the combination of the flash-based fixing device 70 and the laser-based fixing device 80 may provide suitable fixing not only for a monochromatic image formed by the black toner but also for a full-color image greater in toner amount than the monochromatic image.

Incidentally, in the embodiment, the laser-based fixing device 80 employed four laser light sources 81 that emit lights at respective wavelengths corresponding to the absorption wavelength of the color-based toners. This however is not limitative, e.g. the K-fixing laser 81K only may be used to emit a light at a wavelength corresponding to the absorption band to the color-based toners.

Meanwhile, in the embodiment, by producing color-based fixing exposure data on the basis of color-based exposure data and driving the laser light source 81 of the laser-based fixing device 80 depending upon those, the color-based toners on the paper sheet P are irradiated by the corresponding one of laser lights. However, this is not limitative but laser lights may be irradiated to the entire area of the paper sheet P. In such a case, there is not necessarily a need to provide equal the rotation rate of the photoreceptor drum 11 and the conveyance rate of the paper sheet P due to the paper conveyance device 60. In the embodiment, because the laser light source 81 of the laser-based fixing device 80 is to provide a fixing spot in a diameter D2 greater than the diameter D1 of an exposure spot due to the exposure device 13 as noted before, coping is possible for the case where the conveyance rate of the paper sheet P is changed in a range of 0.3-2.0 times the rotation rate of the photoreceptor drum 11.

Furthermore, in the embodiment, the fixing device 50 was structured by combining the flash-based fixing device 70 and the laser-based fixing device 80 together. However, this is not limitative, e.g. in place of the flash-based fixing device 70, it is possible to apply an oven fixing device that non-contact fixing can be made by radiating heat rays, i.e. infrared rays, caused from a heating wire forming a heater

Furthermore, in the embodiment, the laser-based fixing device 80 was structured by combining the laser light source 81 and the rotary multi-surfaced mirror 82 together, this is not limitative. By arranging a plurality of laser light sources 81 in the main scanning direction and driving the respective laser light sources 81, the toners held on the paper sheet P may be fused.

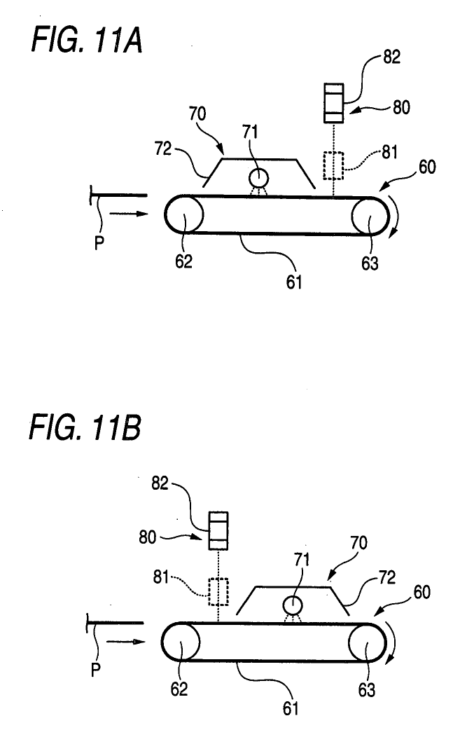

Meanwhile, in the embodiment, the slit 72a was provided in the reflector plate 72 of the flash-based fixing device 70, to irradiate the light of from the laser light source 81 of the laser-based fixing device 80 to the toners on the paper sheet P. However, this is not limitative, e.g. the laser-based fixing device 80 may be arranged downstream with respect to the paper conveyance direction as viewed from the flash-based fixing device 70, say, as shown in FIG. 11A. Meanwhile, as shown in FIG. 11B, the laser-based fixing device 80 can be arranged upstream with respect to the paper conveyance direction as viewed from the flash-based fixing device 70.

Where employing the structure of FIG. 11A or FIG. 11B, it is preferable to provide the distance, of between the flash-based fixing position due to the flash-based fixing device 70 and the laser-based fixing position due to the laser-based fixing device 80, within a range where to reach within 2 seconds at the conveyance rate of the paper sheet P due to the paper conveyance device 60. In case the distance is greater than that, there is a possibility that the toner, fused at the upstream fixing device, cools down and solidifies before entering the downstream fixing device.

Furthermore, in the embodiment, although explanation was on the example the flash-based fixing device 70 had one flash lamp 71, this is not limitative but a plurality of flash lamps may be provided.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image forming section that forms an image on a recording material with an image forming material;
a first irradiating section that irradiates the recording material with a first light; and
a second irradiating section that irradiates the recording material with a second light different from the first light.

2. The image forming apparatus according to claim 1, wherein the first light is an incoherent light, and the second light is a coherent light.

3. The image forming apparatus according to claim 1, wherein the image forming material contains an infrared absorbent having a maximum value of absorption at about 800 to about 1700 nm.

4. The image forming apparatus according to claim 1, wherein the first irradiating section comprises a lamp, and the second irradiating section comprises a laser.

5. The image forming apparatus according to claim 4, wherein the laser selectively irradiate an area on the recording material with the second light, the image forming material being formed on the area.

6. The image forming apparatus according to claim 4, wherein the image forming section comprises an exposure device that selectively exposes a charged photosensitive member to form an electrostatic latent image, and
a diameter of the second light on the recording material is greater than a diameter of an exposure light from the exposure device.

7. The image forming apparatus according to claim 4, wherein the image forming section comprises an exposure device that selectively, exposes a charged photosensitive member to form an electrostatic latent image,
the laser operates to emit a light depending upon an operation signal from the exposure device.

8. An image forming apparatus comprising:
an image forming section that forms an image on a recording material with an image forming material; and
a first heating section and a second heating section, each heating the recording material in non-contact.

9. The image forming apparatus according to claim 8, wherein the first heating section heats the recording material at an entire region thereof, and
the second heating section heats the recording material in a part of the entire region thereof.

10. The image forming apparatus according to claim 8, wherein the first heating section irradiates the recording material with a lamp light.

11. The image forming apparatus according to claim 8, wherein the second heating section irradiates the recording material with a laser light.

12. The image forming apparatus according to claim 11, wherein the image forming material comprises a plurality of image forming materials having different colors, and
the second heating section emits a plurality of laser lights having different wavelengths corresponding to absorption wavelengths of the plurality of image forming materials.

13. The image forming apparatus according to claim 11, wherein the laser light has an intensity density of from about 1.5 W/cm² to about 630 W/cm².

14. The image forming apparatus according to claim 11, wherein the laser light has an emission wavelength of from about 300 nm to about 1600 nm.

15. A fixing device comprising:
a whole-part heating section that heats a recording material having an image, at an entire part thereof; and
a local heating section that heats the recording material at a local portion thereof.

16. The fixing device according to claim 15, wherein the local portion is a region on the recording material that the whole-part heating section insufficiently heats.

17. The fixing device according to claim 15, wherein the local heating section selectively heats an area on the recording material, the image being formed on the area.

18. The fixing device according to claim 15, wherein the whole-part heating section comprises a heater that is arranged along a direction substantially orthogonal to a conveyance direction of the recording material and heats the recording material in non-contact, and
the local heating sections comprises a laser irradiator that irradiates the recording material with a laser light.
